(19) United States
(12) Patent Application Publication
(10) Pub. No.: US 2025/0317435 A1
(43) Pub. Date: Oct. 9, 2025

(54) SYSTEMS AND METHODS FOR ENHANCED AUTHORIZATION AND ESTABLISHING A SECURE, PERSISTENT NETWORK-BASED CONNECTION

(71) Applicant: ASA TECHNOLOGIES, CORPORATION, Provo, UT (US)

(72) Inventors: Troy MAAS, Hellsboro, OR (US); Jay Landon Glenn, Provo, UT (US)

(73) Assignee: ASA TECHNOLOGIES, CORPORATION, Provo, UT (US)

(21) Appl. No.: 18/629,310

(22) Filed: Apr. 8, 2024

(51) Int. Cl. H04L 9/40

(52) U.S. Cl. CPC H04L 63/083; H04L 63/0861

(57) ABSTRACT

Disclosed herein are system, method, and computer program product embodiments for establishing a persistent data connection between an end-user application and an institution, comprising: receiving a request to access an account at the institution associated with the user; obtaining information identifying the user; locating the account associated with the user based on the information identifying the user; retrieving, from the institution, contact information linked to the account associated with the user; generating an authorization code associated with the request to access the account; transmitting the authorization code using the contact information linked to the account associated with the user; prompting the user for the authorization code; and in response to receiving the authorization code from the user, approving the request to access the account.

### BACKGROUND

Authentication techniques for electronically accessing a user's account at an institution typically involve establishing a username and password. For example, a user desiring to use a bank's mobile banking application may be required to enter their account information and thereafter establish a username and password for access to the account. Such authentication techniques, however, are highly susceptible to fraudulent activity, including unauthorized access-a known problem arising specifically in the realm of authentication over computer networks.

For example, many mobile applications require a username and password to access the user's account and then store these credentials in an institution's or a third-party's repository. If the repository is hacked or breached the user's credentials may be compromised and an unauthorized individual may attempt to gain access to the user's sensitive data. For example, in September 2017, the consumer credit reporting agency Equifax announced a data breach that exposed the personal information of 147 million people. Such major data breaches are becoming increasingly common and securing sensitive data in a networked-computing environment is a wide-spread technical concern in the industry.

Moreover, because of the risk associated with use of usernames and passwords, a user is typically required to re-authenticate after a short period of time. Such re-authentication can cause disturbance to the user attempting to access their account, especially in cases where the user has forgotten their password. In such a case, the user must go through a process to reset their password before access can be regained. What is needed are improved techniques for electronically accessing a user's accounts that avoid the use of authentication techniques that are prone to fraud, and that allow persistent access to account data based on increased confidence that the user requesting access is authorized to access the account.

### BRIEF SUMMARY

Disclosed herein are system, apparatus, device, method and/or computer program product embodiments, and/or combinations and sub-combinations thereof, for establishing a persistent data connection between an end-user application and an institution associated with a user. Some embodiments relate to a method comprising: receiving a request to access an account at the institution associated with the user; obtaining information identifying the user; locating the account associated with the user based on the information identifying the user; retrieving, from the institution, contact information linked to the account associated with the user; generating an authorization code associated with the request to access the account; transmitting the authorization code using the contact information linked to the account associated with the user; prompting the user for the authorization code; and in response to receiving the authorization code from the user, approving the request to access the account, wherein the approval authorizes the end-user application to access the account at the institution associated with the user.

Some embodiments relate to a system comprising: a memory and at least one processor coupled to the memory and configured to receive a request to access an account at the institution associated with the user; obtain information identifying the user; locate the account associated with the user based on the information identifying the user; retrieve, from the institution, contact information linked to the account associated with the user; generate an authorization code associated with the request to access the account; transmit the authorization code using the contact information linked to the account associated with the user; prompt the user for the authorization code; and in response to receiving the authorization code from the user, approve the request to access the account, wherein the approval authorizes the end-user application to access the account at the institution associated with the user.

Some embodiments relate to a non-transitory computer-readable device having instructions stored thereon. When the instructions are executed by at least one computing device, the instructions cause the at least one computing device to perform operations comprising: receiving a request to access an account at the institution associated with the user; obtaining information identifying the user; locating the account associated with the user based on the information identifying the user; retrieving, from the institution, contact information linked to the account associated with the user; generating an authorization code associated with the request to access the account; transmitting the authorization code using the contact information linked to the account associated with the user; prompting the user for the authorization code; and in response to receiving the authorization code from the user, approving the request to access the account, wherein the approval authorizes the end-user application to access the account at the institution associated with the user.

### BRIEF DESCRIPTION OF THE DRAWINGS

The accompanying drawings are incorporated herein and form a part of the specification.

FIG. 1 depicts an exemplary system for establishing a connection between an end-user application and one or more institutions, according to some embodiments.

FIG. 2 is a flowchart illustrating an example process for establishing a connection between an end-user application and one or more institutions, according to some embodiments.

FIG. 3 is a flowchart illustrating an example process for locating a user's account at an institution, according to some embodiments.

FIG. 4 is a flowchart illustrating an example process for providing elevated authorization to an end-user application, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for establishing persistent data connections between end-user applications and one or more institutions. The end-user applications may be operated by a user to view, manage, or otherwise interact with the user's accounts at the one or more institutions. Embodiments presented herein enable authorization of end-user applications (through validation of the user) to access the user's accounts without requiring the use of authentication techniques that are prone to fraud, such as usernames and passwords.

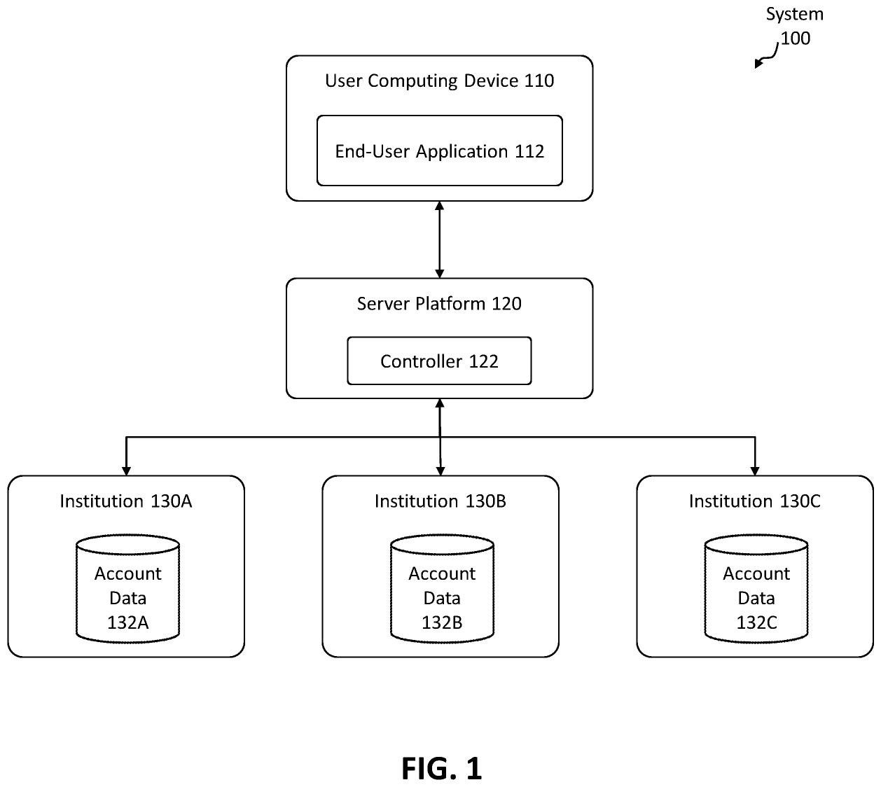

FIG. 1 depicts an exemplary system 100 for establishing a connection between an end-user application and one or more institutions, according to some embodiments. System 100 includes user computing device 110, server platform 120, and institutions 130A, 130B, and 130C. Institutions 130A, 130B, and 130C are illustrated for representative purposes, but a skilled artisan will appreciate that server platform 120 may be connected to any number of institutions. User computing device 110 may be a mobile device (e.g., tablet PC, a laptop, a smartphone, etc.)), a desktop computer, a server, a mainframe, a kiosk, or any other type of computing device operable by a user. Server platform 120 may include one or more computing devices configured to process requests from user computing device 110 and/or institutions 130A, 130B, and 130C. User computing device 110, server platform 120, and institutions 130A, 130B, and 130C may be connected by a communications network such as the Internet. The communications network may include wired and/or wireless segments. Moreover, User computing device 110, server platform 120, and institutions 130A, 130B, and 130C may be configured to communicate securely using various communication protocols such as, but not limited to, TLS/SSL, IPsec, SSH, or PGP.

Institutions 130A, 130B, and 130C may denote any institution at which a user establishes an account. Although embodiments described herein may refer to financial institutions such as, but not limited to, banks, credit unions, brokerage firms, insurance companies, mortgage companies, and credit reporting agencies, the disclosed technology and embodiments are not limited to such institutions. For example, institutions may further encompass academic institutions, healthcare institutions (e.g., hospitals, clinics, doctor offices, labs, etc.), retail companies, private corporations, government agencies and departments, charities, etc. Institutions may also encompass aggregators that gather and store account data associated with multiple institutions.

Institutions 130A, 130B, and 130C may store user account data in data repositories 132A, 132B, and 132C, respectively. Data repositories 132A, 132B, and 132C may include one or more physical or logical data stores, which may each be any type of structured or unstructured data store, such as a relational, document-oriented, or object-oriented database. For example, user account data stored in data repositories 132A, 132B, and 132C may include account numbers, account holder information, contact information, balances, debit transactions, credit transactions, transaction history, etc.

User computing device 110 may include an end-user application 112 executing on the computing device. One example of end-user application 112 is the ASA Vault App offered by ASA Technologies, Corporation. End-user application 112 may be operated by the user to access a user's account data at one or more of institutions 130A, 130B, and 130C. End-user application 112 may be managed by one of institutions 130A, 130B, and 130C or may be a third-party application authorized to access data from institutions 130A, 130B, and 130C. For example, end-user application 112 may be a mobile banking application designed to access and/or manage data associated with a user's accounts (e.g., checking, savings, or brokerage accounts). Data may be used to populate end-user application 112 for the purpose of, but not limited to, viewing and managing funds and/or other assets, debts, or property held within the user's account at the associated institution.

In some embodiments, end-user application 112 may access data from data repositories 132A, 132B, and 132C via server platform 120. Server platform 120 may include a controller configured to process requests from end-user application 112 and retrieve information from data repositories 132A, 132B, and 132C. One example of controller 122 is the ASA Auth platform offered by ASA Technologies, Corporation. In some embodiments, server platform 120 may publish an application programming interface (API) that allows applications, such as end-user application 112, to interface with controller 122. The server platform API may receive requests from end-user application 112 in the form of API commands, which may be processed by controller 122. Controller 122 may then communicate with institution 130A, 130B, and/or 130C to access data from data repositories 132A, 132B, and/or 132C based on the received command. For example, end-user application 112 may submit a command to the server platform API to retrieve account balances from institution 130A. In such a case, controller 122 may process the command, and, if end-user application 112 is authorized to access the requested account balances, retrieve the user's account balances from data repository 132A. Controller 122 may then return the retrieved account balances to end-user application 112.

In some embodiments, Institutions 130A, 130B, and 130C may publish respective APIs that allow controller 122 to access and/or manage data stored in data repositories 132A, 132B, and 132C. Alternatively, controller 122 may have direct access to data repositories 132A, 132B, and 132C.

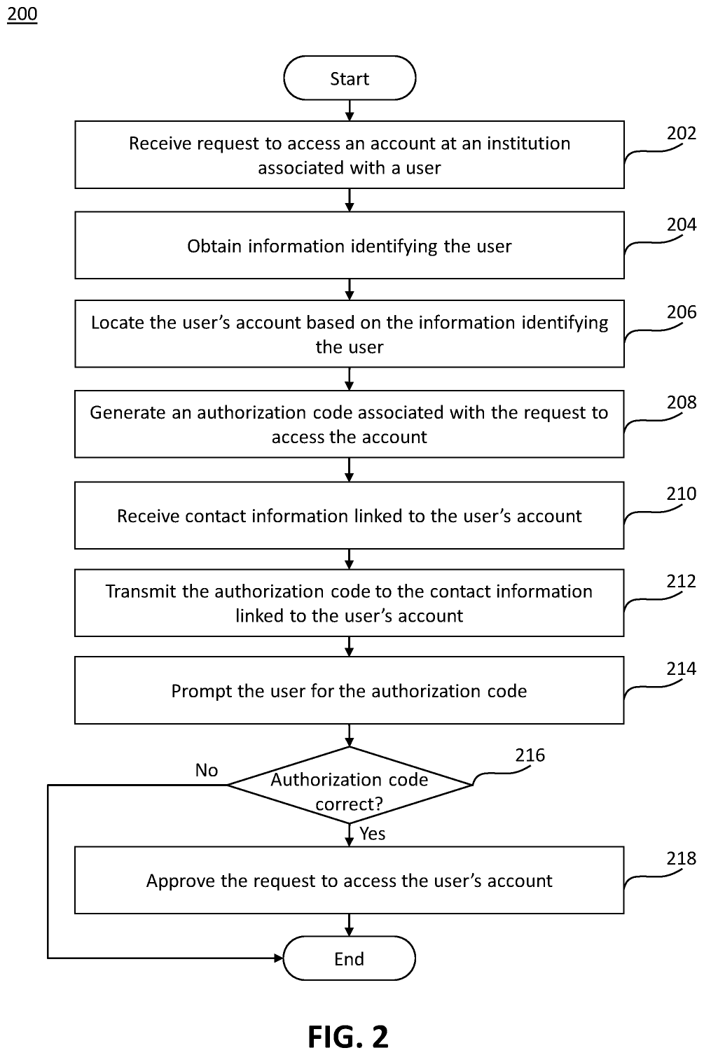

In some embodiments, a user first establishes an account with end-user application 112. The user then selects one or more institutions with which to establish a connection. End-user application 112 may provide a user interface that presents the user with a plurality of institutions to select. Additionally or alternatively, end-user application may provide a search function to allow a user to search for a desired institution, for example by the institution's name. Once a user selects an institution, end-user application 112 initiates a process to locate the user's account(s) at the institution and authorize the end-user application to access data associated with the user's account(s). Exemplary processes are discussed further with respect to FIGS. 2, 3, and 4 below.

FIG. 2 is a flowchart illustrating an example process 200 for establishing a connection between an end-user application and one or more institutions, according to some embodiments. Process 200 may be performed by processing logic that may comprise hardware (e.g., circuitry, dedicated logic, programmable logic, microcode, etc.), software (e.g., instructions executing on a processing device), or a combination thereof. One or more of the steps in FIG. 2 may be performed by end-user application 112 of user computing device 110, alone or in conjunction with controller 122 of server platform 120. In some embodiments, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2. The steps shown in FIG. 2 may be implemented as computer-readable instructions stored on computer-readable media, where, when the instructions are executed, cause a processor to perform the process of FIG. 2.

At 202, a request is received to access a user's account at an institution. For example, end-user application 112 may receive such a request when a user selects an institution with which to connect, such as the user's bank or mortgage lender. At 204, information identifying the user is obtained. In some embodiments, the information identifying the user may be retrieved from user computing device 110 or server platform 120 by end-user application 112. For example, when a user establishes an account with end-user application 112, the user may provide their first name, last name, social security number (SSN), phone number, email address, or other identifying information. This information may be stored and retrieved by end-user application 112 when the request to access the user's account information is received. In some embodiments, the user may be prompted within end-user application 112 for identifying information, such as the user's name or last four digits of the user's SSN.

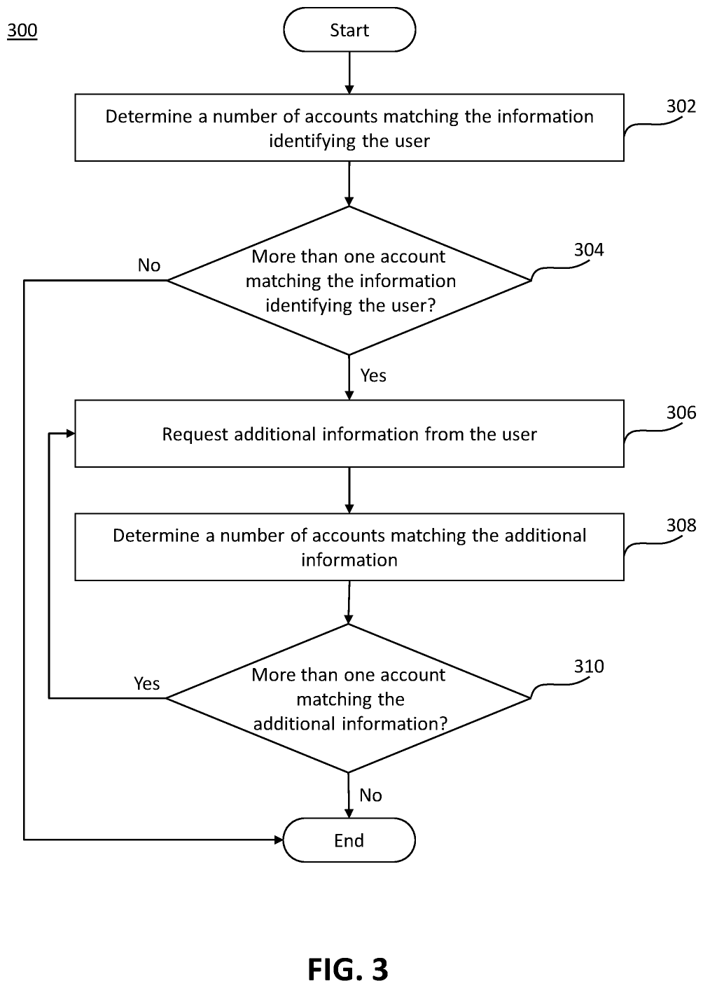

At 206, the user's account is located based on the information identifying the user. For example, end-user application 112 may transmit the user's name (i.e., the information identifying the user) to controller 122, which may access a list of accounts at the institution for which the user's name matches the name of the primary account holder. A goal of 206 is to locate a single account at the institution so that the user can verify that they are authorized to access that account. The user, however, may be associated with multiple accounts at the institution, or the user's account may not be identifiable from only the initial information identifying a user (e.g., from only the user's name). An exemplary process for locating a single account associated with the user is therefore discussed in more detail with respect to FIG. 3.

Turning to FIG. 3, FIG. 3 is a flowchart illustrating an example process 300 for locating a user's account at an institution, according to some embodiments. In some embodiments, process 300 may be performed as part of step 206 of FIG. 2. Process 300 may further be performed by processing logic that may comprise hardware (e.g., circuitry, dedicated logic, programmable logic, microcode, etc.), software (e.g., instructions executing on a processing device), or a combination thereof. One or more of the steps in FIG. 3 may be performed by end-user application 112 of user computing device 110 and/or controller 122 of server platform 120. In some embodiments, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3. The steps shown in FIG. 3 may be implemented as computer-readable instructions stored on computer-readable media, where, when the instructions are executed, cause a processor to perform the process of FIG. 3.

At 302, a number of accounts matching the information identifying the user is determined. For example, if the institution is the user's retail bank, the user may have only one account (e.g., a checking account), or the user may have multiple accounts (e.g., checking, savings, brokerage, etc.). At 304, if the number of accounts matching the information identifying the user is determined to be one, process 300 ends and the identified account is returned for further processing.

If the number of accounts matching the information identifying the user is determined to be more than one at 304, additional information related to an account associated with the user is requested from the user at 306. Such information may include, but is not limited to, SSN (or last four digits of SSN), birthdate, telephone number, physical address, email address, a date that an account was established, an approximate account balance, an account number, a credit card number associated with an account, or answers to secret questions setup by the user when the account was established (e.g., pet's name).

For example, if the institution holds accounts for multiple users having the same name, additional information (e.g., the user's SSN) may be needed to locate the correct account. Similarly, if the user has established multiple accounts at the same institution, additional information (e.g., approximate account balance or account number) may be needed to narrow the search to a single account. In some embodiments, the additional information may be automatically retrieved from user computing device 110 or server platform 120 by end-user application 112. For example, the information may be obtained from information provided by the user when the user originally established an account with end-user application 112. Additionally or alternatively, the user may be prompted within end-user application 112 for the additional information.

At 308, a number of accounts matching the additional information is determined. At 310, if the number of accounts matching the additional information is determined to be one, process 300 ends and the identified account is returned for further processing. If the number of accounts matching the additional information is determined to be more than one at 310, the process returns to 306 to again request additional information from the user. Steps 306, 308, and 310 may be repeated until a single account associated with the user is identified.

In some embodiments, the additional information requested from the user is requested according to an ordered hierarchy. For example, the ordered hierarchy may begin with SSN, followed by physical address, telephone number, email address, and finally account number. In other words, at 306, the user may first be prompted for their SSN (or last four digits of their SSN). If a single account could not be located, the user may next be prompted for their physical address, and so on. The ordered hierarchy of additional information may be stored within server platform 120 and/or user computing device 110.

In some embodiments, server platform 120 defines a default ordered hierarchy of additional information to be requested from the user. In some embodiments, the ordered hierarchy is configurable by each institution and may differ between institutions. Because different institutions may store different account information, or manage account information differently, this configurability enables efficient location of user accounts based on the institution's own know-your-customer (KYC) data. Thus, by allowing the institution to configure the information requested from the user, process 300 ensures that the located account is actually associated with the user.

Turning back to FIG. 2, once an account associated with the user is located, process 200 proceeds to 208. At 208, contact information linked to the user's account is retrieved. In some embodiments, controller 122 of server platform 120 may retrieve the contact information from the institution (e.g., one of institutions 130A, 130B, and 130C). The contact information may include a telephone number, email address, or any other type of contact information linked to the user's account.

At 210, an authorization code associated with the request to access the user's account is generated. In some embodiments, the authorization code may be generated by server platform 120. For example, a random, temporary six-digit personal identification number (PIN) may be generated and linked to the request. A skilled artisan will recognize that any randomly-generated code may be used for purposes of process 200. In some embodiments, the generated authorization code is valid only for a defined period of time, for example, five minutes. When the period of time expires, the authorization code is no longer valid and cannot be used for approval of the request. Additionally or alternatively, the authorization code may take the form of a verification message to be sent to one or more of the user's devices (e.g., “Do you authorize access to account #XXX at institution XXX?”).

Typically, when an individual establishes an account at an institution, the user provides contact information to be associated with the account. For example, when an individual opens a checking account at the bank, the individual may provide a telephone number, email address, physical address, etc. By retrieving the contact information directly from the institution, process 200 ensures that the generated authorization code is provided to the correct individual associated with the account, minimizing any threat of fraudulent activity. The process therefore not only avoids the use of traditional usernames and passwords, but also improves upon traditional two-factor authentication techniques (which typically require a username and password (or similar) as a first factor of authentication) by removing the need for a first factor of authentication altogether. In other words, the process discussed with respect to FIG. 2 provides a level of security often associated with two-factor authentication, but through use of only a single generated authorization code.

At 212, the generated authorization code is transmitted to the contact information linked to the user's account. In some embodiments, step 212 may be performed by controller 122 of server platform 120. For example, if the contact information includes a telephone number, the authorization code may be transmitted in a text message (e.g., via SMS), or a call may be placed to the telephone number to verbally convey the authorization code. Similarly, if the contact information includes an email address, the authorization code may be transmitted in an email. In some embodiments, the authorization code may be transmitted in multiple forms to ensure the user has access to the code. For example, if the contact information includes both a telephone number and an email address, both a text message and an email containing the authorization code may be transmitted.

At 214, the user is prompted for the authorization code. In some embodiments, end-user application 112 presents an input interface that allows the user to enter the authorization code. For example, if end-user application 112 is executing on a mobile phone, the user may be presented with a screen on their phone to enter the authorization code. In some embodiments, the user is prompted with a verification message asking the user to select yes or no, rather than to enter an alphanumeric code. For example, a screen may be presented on a user's mobile device asking, “Do you authorize access to account #XXX at institution XXX?”

At 216, a determination is made as to whether the authorization code entered by the user is correct. In some embodiments, such a determination may be made by controller 122 of server platform 120. If the authorization code is determined to be correct, the request to access the user's account is approved at 218, which authorizes end-user application 112 to access data associated with the user's account at the institution. For example, if the institution is a bank, end-user application 112 may be authorized to retrieve and display the user's checking account information upon request.

In some embodiments, once the request is approved, end-user application 112 may be authorized to access all accounts held at the institution that are associated with the user. Such additional accounts may be identified based on the information used to locate the user's original account (e.g., account holder name or SSN), or by the institution. For instance, the institution may maintain records in a managed data repository linking accounts with the same primary account holder. Thus, if a request to access one of the user's accounts (e.g., a checking account) is approved, end-user application 112 may automatically be authorized to access the user's other accounts (e.g., a savings account) as well.

At 216, if the authorization code entered by the user is not correct, process 200 ends without approving the request to access the user's account. Because the authorization code is transmitted only to the contact information associated with the user's account at the institution, the determination at 216 prevents fraudulent access to a user's account by assuring only authorized users receive the authorization code. In some embodiments, to avoid inadvertent mistakes, the user may be given a specified number of chances to enter the correct authorization code before process 200 ends.

Once the request of process 200 is approved at 218, a persistent data connection is established between the end-user application (e.g., end-user application 112) and the institution (e.g., institution 130A, 130B, or 130C). That is, the end-user application is provided continued, and in some embodiments indefinite, access to the user's account data at the institution, without requiring re-authorization (unless expressly desired by the institution). Such a persistent connection is made possible based on a level of confidence provided by the authorization process. Because an authorization code is transmitted using the institution's known contact information linked to a user's account, authentication techniques that are prone to fraud, such as username and password, can be avoided. In fact, in some embodiments, the user is never required to setup a username and password with the institution in order to access and manage account data. Such an embodiment thus reduces storage requirements for the institution, obviating the need for a database or table to store electronic login credentials for the user. Doing so also eliminates a point of attack that malicious actors target seeking to gain access to user accounts, thus making the system more secure. If the user enters the correct authorization code, the institution gains a high degree of confidence that the user is who they purport to be, and that the user has authorization to access the accounts held at the institution.

Moreover, because the generated authorization codes are ephemeral, only valid for a short time, process 200 reduces the risk of authentication information being accessed by unauthorized parties. For example, server platform 120 is only required to store the generated authentication code for the lesser of (1) the time the code is valid, or (2) until process 200 concludes. This reduces the risk of unauthorized access to the generated authentication code, and even if the code were exposed (in a worst-case scenario), the built-in expiration time reduces the risk that the code could be used to authenticate the unauthorized party.

Additionally, process 200 offloads the user authentication process from the institution to the server platform. This offloading removes the need for individual institutions to implement their own authentication systems, increasing the efficiency of the institution's processes. Each institution is thus able to store only data pertinent to their normal operations (e.g., banking account data), without the need to manage authentication or external access to account data themselves.

Further, the use of the server platform (e.g., server platform 120) for authentication and access to institution data prevents direct connections between the end-user application and the institution. Such an architecture adds a layer of security between the end-user application (and thus the user's device) and the institution. In some embodiments, for instance, server platform 120 may continuously or periodically monitor end-user application for potentially fraudulent activity following approval of the request at 218. For example, server platform may record the location of the user's device when the request is approved. When a future request for account data is received, server platform 120 may check the user's location to determine if the user device is located in a significantly different location. If so, server platform 120 may temporarily suspend the user's access to account data, requiring new authorization to access the user's account data. The institution can therefore remain protected against fraudulent activity without the need to implement such monitoring within their own systems, and while allowing the persistent data connection to the end-user application once the request is approved at 218. Those skilled in the art will appreciate that the server platform may monitor the user's device for fraudulent activity in a variety of ways, and location monitoring is merely provided as an example.

In some embodiments, the persistent data connection is accomplished through use of a unique identifier stored by the institution and/or server platform, and provided by the end-user application upon request for the user's account data. For example, once the request is approved at 218, controller 122 of server platform 120 may generate an identifier to be associated with the approved request. The identifier may be provided to the end-user application for use in future requests for the user's account data. In some embodiments, the unique identifier may be stored only by the institution and server platform without providing the identifier to the end-user application, avoiding any chance of unauthorized access to the identifier on the user's device. In such embodiments, the server platform may associate the identifier with the user of the end-user application and provide the identifier to the institution upon request from the end-user application for the user's account data. In some embodiments, the persistent data connection is established via one or more persistent Hypertext Transfer Protocol (HTTP) connections. In such a case, TCP connections may be established between the end-user application, the server platform, and the institution, and the connections are continuously left open for a desired time period, without requiring a new connection to be established each time the end-user application requests account data from the institution. In some embodiments, a persistent HTTP connection is established only between the server platform and the institution.

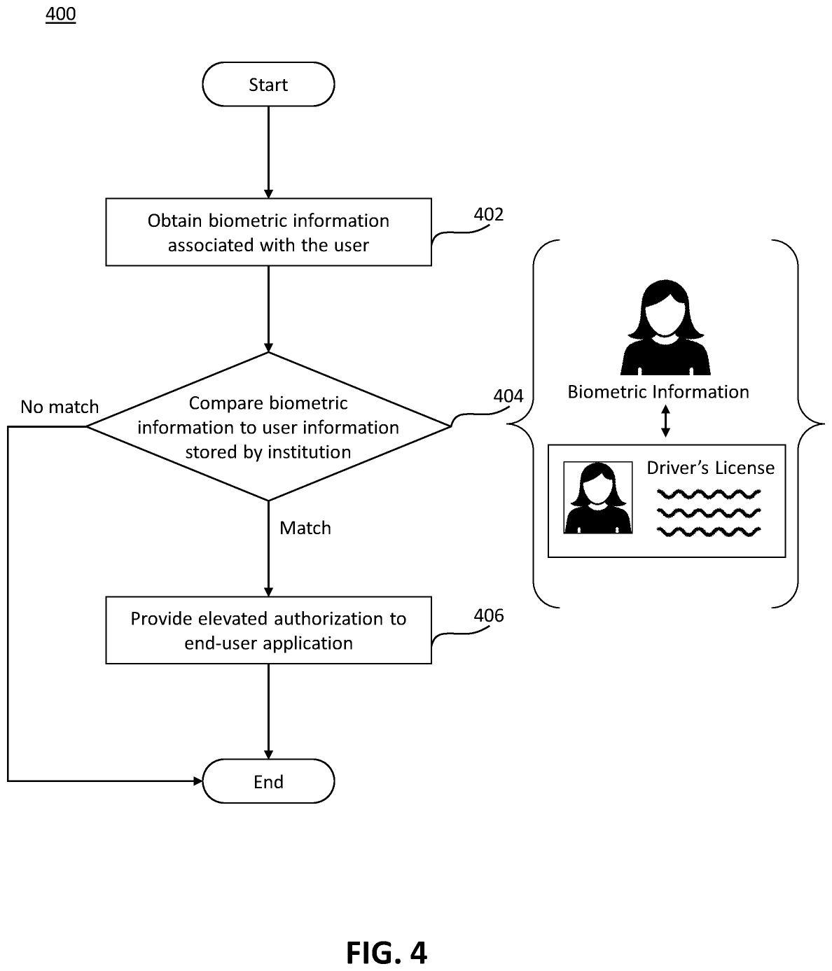

FIG. 4 is a flowchart illustrating an example process for providing elevated authorization to an end-user application, according to some embodiments. Process 400 may be performed by processing logic that may comprise hardware (e.g., circuitry, dedicated logic, programmable logic, microcode, etc.), software (e.g., instructions executing on a processing device), or a combination thereof. One or more of the steps in FIG. 4 may be performed by end-user application 112 of user computing device 110, alone or in conjunction with controller 122 of server platform 120. In some embodiments, one or more of the steps shown in FIG. 4 may be omitted, repeated, and/or performed in a different order than the order shown in FIG. 4. Accordingly, the scope of the invention should not be considered limited to the specific arrangement of steps shown in FIG. 4. The steps shown in FIG. 4 may be implemented as computer-readable instructions stored on computer-readable media, where, when the instructions are executed, cause a processor to perform the process of FIG. 4.

In some embodiments, process 400 is used to provide step-up authorization to a user based on additional verification. Such additional verification may be performed as part of or following process 200 of FIG. 2 and increases the confidence that the user is authorized to perform actions with respect to accounts held at an institution, further reducing any threat of fraudulent-activity. In some embodiments, process 400 may be initiated by the user via end-user application 112 executing on the user's device, or by server platform 120 in response to a request requiring step-up authorization. Further, in some embodiments, process 400 may be initiated only following approval of the request at 218 of process 200 of FIG. 2. At 402, biometric information associated with the user is obtained. The biometric information may include, but is not limited to, an image of a user's face, fingerprints, a voice sample, an iris or retina scan, a palm or finger vein pattern, or any combination thereof. For example, a user's mobile device (e.g., user computing device 110) may be used to capture an image of the user's face or a fingerprint.

At 404, the obtained biometric information is compared to user information stored by the institution. In some embodiments, step 404 may be performed by controller 122 (or another component) of server platform 120. For example, controller 122 may retrieve the user information from the institution and perform a comparison of the obtained biometric information to the retrieved user information. The user information stored by the institution may include biometric-related information such as, but not limited to, identification documents (e.g., a driver's license or passport), or previously provided fingerprints, voice samples, iris scans, retina scans, or palm or finger vein patterns. For example, a user may provide a driver's license, passport, or other biometric-related information when establishing an account at an institution (e.g., opening a checking account at a bank).

If it is determined at 404 that the obtained biometric information does not match the user information stored by the institution, process 400 ends without providing elevated authorization to the end-user application. In some embodiments, the failure to provide valid biometric information in process 400 may also trigger termination of process 200, or removal of any authorization provided by process 200.

If it is determined at 404 that the obtained biometric information matches the user information stored by the institution, elevated authorization is provided to the end-user application (e.g., end-user application 112) at 406. In addition to allowing the user to view the user's account information within the end-user application, the elevated authorization may further permit the end-user application to execute financial transactions (e.g., make a payment, transfer money, execute a trade, etc.) on the account associated with the user. Again, such authorization is provided without the need for the user to provide a username or password at any point during the process. Instead, because the end-user application has already been approved to access the user's account data at the institution, the institution can be confident that the user providing the biometric information is not doing so fraudulently. That is, the user providing the biometric information is the individual associated with the contact information linked to the user's account, as discussed with respect to step 208 of FIG. 2.

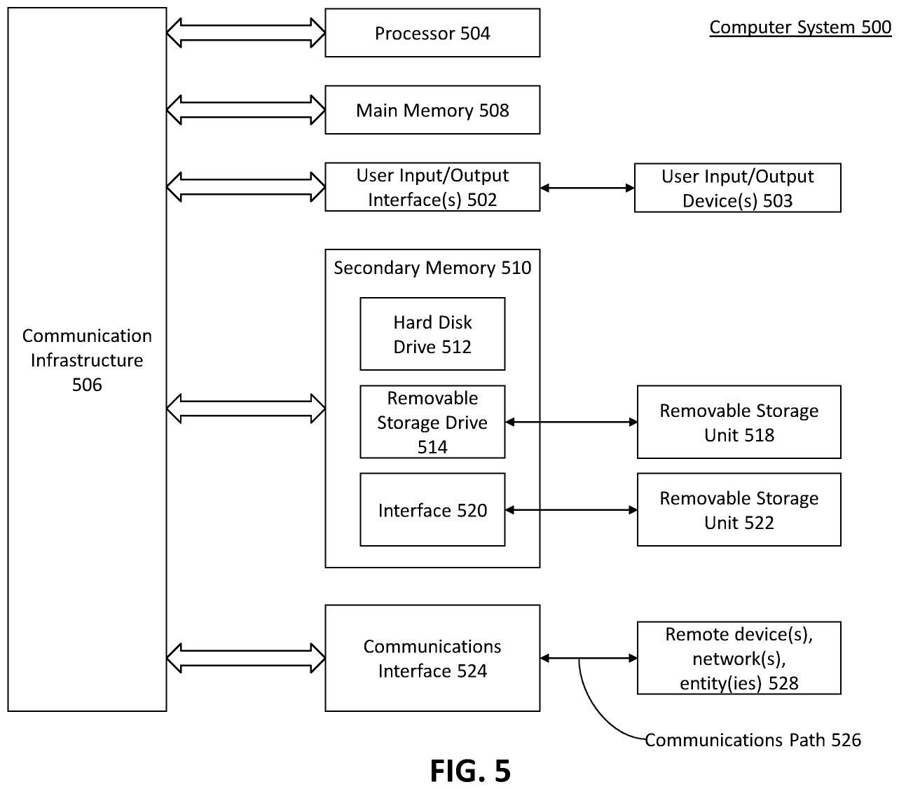

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for establishing a persistent data connection between an end-user application and an institution associated with a user, comprising:
receiving a request to access an account at the institution associated with the user;
obtaining information identifying the user, wherein the information identifying the user is not a username or password;
locating the account associated with the user based on the information identifying the user;
retrieving, from the institution, contact information linked to the account associated with the user;
generating an authorization code associated with the request to access the account;
transmitting the authorization code using the contact information linked to the account associated with the user;
prompting the user for the authorization code; and
in response to receiving the authorization code from the user, approving the request to access the account, wherein the approval authorizes the end-user application to access the account at the institution associated with the user.

2. The computer-implemented method of claim 1, wherein locating the account further comprises:
determining whether a number of accounts matching the information identifying the user is greater than one;
in response to determining that the number of accounts matching the information identifying the user is greater than one, requesting from the user additional information related to the account associated with the user; and
locating the account associated with the user based on the additional information.

3. The computer-implemented method of claim 2, wherein the additional information requested from the user is selected by the institution.

4. The computer-implemented method of claim 1, wherein the contact information linked to the account associated with the user includes one of a phone number and an email address.

5. The computer-implemented method of claim 1, further comprising:
obtaining biometric information associated with the user;
comparing the biometric information to user information stored by the institution; and
in response to the biometric information matching the user information stored by the institution, providing elevated authorization to the end-user application, the elevated authorization permitting the end-user application to execute transactions on the account associated with the user.

6. The computer-implemented method of claim 5, wherein the user information stored by the institution is an image from one of a driver's license or passport.

7. The computer-implemented method of claim 1, wherein the persistent data connection between the end-user application and the institution comprises a persistent HTTP connection.

8. A system for establishing a persistent data connection between an end-user application and an institution associated with a user, comprising:
a memory; and
at least one processor coupled to the memory and configured to:
receive a request to access an account at the institution associated with the user;
obtain information identifying the user, wherein the information identifying the user is not a username or password;
locate the account associated with the user based on the information identifying the user;
retrieve, from the institution, contact information linked to the account associated with the user;
generate an authorization code associated with the request to access the account;
transmit the authorization code using the contact information linked to the account associated with the user;
prompt the user for the authorization code; and
in response to receiving the authorization code from the user, approve the request to access the account, wherein the approval authorizes the end-user application to access the account at the institution associated with the user.

9. The system of claim 8, wherein to locate the account, the at least one processor is further configured to:
determine whether a number of accounts matching the information identifying the user is greater than one;
in response to determining that the number of accounts matching the information identifying the user is greater than one, request from the user additional information related to the account associated with the user; and
locate the account associated with the user based on the additional information.

10. The system of claim 9, wherein the additional information requested from the user is selected by the institution.

11. The system of claim 8, wherein the contact information linked to the account associated with the user includes one of a phone number and an email address.

12. The system of claim 8, the at least one processor further configured to:
obtain biometric information associated with the user;
compare the biometric information to user information stored by the institution; and
in response to the biometric information matching the user information stored by the institution, provide elevated authorization to the end-user application, the elevated authorization permitting the end-user application to execute financial transactions on the account associated with the user.

13. The system of claim 12, wherein the user information stored by the institution is an image from one of a driver's license or passport.

14. A non-transitory computer-readable device having instructions stored thereon that, when executed by at least one computing device, cause the at least one computing device to perform operations comprising:
receiving a request to access an account at an institution associated with a user;
obtaining information identifying the user, wherein the information identifying the user is not a username or password;
locating the account associated with the user based on the information identifying the user;
retrieving, from the institution, contact information linked to the account associated with the user;
generating an authorization code associated with the request to access the account;
transmitting the authorization code using the contact information linked to the account associated with the user;
prompting the user for the authorization code; and
in response to receiving the authorization code from the user, approving the request to access the account, wherein the approval authorizes an end-user application to access the account at the institution associated with the user.

15. The non-transitory computer-readable device of claim 14, wherein to locate the account, the operations further comprise:
determining whether a number of accounts matching the information identifying the user is greater than one;
in response to determining that the number of accounts matching the information identifying the user is greater than one, requesting from the user additional information related to the account associated with the user; and
locating the account associated with the user based on the additional information.

16. The non-transitory computer-readable device of claim 15, wherein the additional information requested from the user is selected by the institution.

17. The non-transitory computer-readable device of claim 14, wherein the contact information linked to the account associated with the user includes one of a phone number and an email address.

18. The non-transitory computer-readable device of claim 14, the operations further comprising:
obtaining biometric information associated with the user;
comparing the biometric information to user information stored by the institution; and
in response to the biometric information matching the user information stored by the institution, providing elevated authorization to the end-user application, the elevated authorization permitting the end-user application to execute financial transactions on the account associated with the user.

19. The non-transitory computer-readable device of claim 18, wherein the user information stored by the institution is an image from one of a driver's license or passport.

20. The non-transitory computer-readable device of claim 14, wherein the persistent data connection between the end-user application and the institution comprises a persistent HTTP connection.
